(19) United States
(12) Patent Application Publication
(10) Pub. No.: US 2012/0123564 A1
(43) Pub. Date: May 17, 2012

(54) DRIVE CONTROL APPARATUS AND DRIVE CONTROL METHOD FOR ACTUATOR

(75) Inventors: Hisashi YAJIMA, Tsukuba-shi (JP); Nobuhiro Fujiwara, Moriya-shi (JP)

(73) Assignee: SMC Kabushiki Kaisha, Tokyo (JP)

(21) Appl. No.: 13/291,505

(22) Filed: Nov. 8, 2011

(30) Foreign Application Priority Data
Nov. 15, 2010 (JP) 2010-255122

(51) Int. Cl. G05D 3/00; G05B 13/02

(52) U.S. Cl. 700/33; 700/302

(57) ABSTRACT

An actuator drive control apparatus is equipped with a movement distance setting means for setting a movement distance of a displaceable member, a movement time setting means for setting a movement time, a target value calculating means for calculating a target value of a displacement amount or a displacement velocity of the displaceable member at an arbitrary timing based on the movement distance and the movement time, and a drive controller for generating driving power based on the displacement amount or the displacement velocity target value of the displaceable member and sending the drive power to an actuator.

### CROSS-REFERENCE TO RELATED APPLICATION

This application is based upon and claims the benefit of priority from Japanese Patent Application No. 2010-255122 filed on Nov. 15, 2010, of which the contents are incorporated herein by reference.

### BACKGROUND OF THE INVENTION

1. Field of the Invention

The present invention relates to an actuator drive control apparatus and an actuator drive control method for displacing a displaceable member equipped with an actuator to a predetermined position.

2. Description of the Related Art

Actuators are known, which are configured as driving mechanisms for displacing a displaceable member, in accordance with controls from an actuator drive control apparatus. The actuator drive control apparatus comprises various control means and circuits, etc., for displacing the displaceable member in accordance with desired operations (see, for example, Japanese Laid-Open Patent Publication No. 09-308282 and Japanese Laid-Open Patent Publication No. 08-272422). In such configurations, detailed operations are set, such as acceleration, a constant velocity, deceleration and the like, to enable the displaceable member to be displaced with high precision.

For example, in the velocity instruction generating apparatus disclosed in Japanese Laid-Open Patent Publication No. 09-308282, as a configuration for controlling a movable body of a movement mechanism, a constant input means, an acceleration command means, a constant velocity command generating means, a velocity command synthesizing means, etc., are provided. Using each of such means, by generating a velocity command required for a given movement amount of the movable body, a drive control of a motor (actuator) is carried out.

Further, a robot control apparatus as disclosed in Japanese Laid-Open Patent Publication No. 08-272422 is equipped as hardware with an interface, a CPU, a ROM and the like, wherein basic driving patterns of the robot are set in the hardware, and the robot is operated following such basic driving patterns.

However, in the velocity instruction generating apparatus disclosed in Japanese Laid-Open Patent Publication No. 09-308282, for controlling driving of the movable body, a total movement amount, a velocity-position conversion constant, a maximum velocity, a motor current-velocity conversion constant, a maximum motor current, and an acceleration time are input to the constant input means. The user is required to calculate beforehand such various values, based on the movement distance and the movement time of the movable body, which is moved by the movement mechanism.

Further, even with the robot control apparatus disclosed in Japanese Laid-Open Patent Publication No. 08-272422, a configuration is provided in which, as basic conditions for controlling driving of a robot, a set maximum velocity during movement, and a set acceleration/deceleration until the set maximum velocity is reached are input, and it is still required for the user to calculate each of such values beforehand.

However, to control driving of an actuator, the user is required to perform calculations for detailed driving conditions (e.g., the velocity of the displaceable member, and times required in relation to the velocity) apart from the initially determined movement distance and the movement time of the displaceable member, which causes problems in that a heavy work burden is placed on the user, or human-induced calculation errors can occur.

### SUMMARY OF THE INVENTION

The present invention has the object of providing an actuator drive control apparatus and an actuator drive control method, which overcome and solve the aforementioned problems, and in which, by setting a movement distance and a movement time of a displaceable member of an actuator, detailed operations of the displaceable member can be determined, and the displaceable member can be displaced highly precisely. In accordance therewith, the work burden imposed on the user can be lessened, and the occurrence of malfunctions caused by human mistakes can be avoided.

To achieve the aforementioned objects, the present invention provides an actuator drive control apparatus for displacing a displaceable member of an actuator to a predetermined position, comprising a movement distance setting means for setting a movement distance of the displaceable member from a movement start point to the predetermined position, a movement time setting means for setting a movement time for the displaceable member to move from the movement start point to the predetermined position, a target value calculating means for automatically dividing the movement time into an acceleration time, a constant velocity time, and a deceleration time based on preset information related to a displacement velocity when the displaceable member is displaced, and for calculating a target value of a displacement amount or a displacement velocity of the displaceable member at an arbitrary timing based on the divided movement time and the movement distance, and a drive control means for displacing the displaceable member to the predetermined position by controlling driving of the actuator based on the target value of the displacement amount or the displacement velocity of the displaceable member.

In accordance therewith, simply by setting the movement distance and the movement time of the displaceable member, the movement time is automatically divided into an acceleration time, a constant velocity time, and a deceleration time, and a target value of a displacement amount or a displacement velocity of the displaceable member at any arbitrary timing can be obtained. Owing thereto, during drive control of the actuator, the displaceable member can be displaced with high precision in accordance with the target value. For example, in the case that a workpiece is transported or pressed by the displaceable member to reach a predetermined position, the workpiece can be displaced to a precise position within a desired time. Further, since the user is not required to calculate detailed driving conditions such as the velocity, the time over which the velocity is maintained, and the like, the work burden on the user can significantly be lessened, and malfunctions caused by human errors can be avoided.

In this case, the information related to the displacement velocity is a time ratio of the acceleration time, the constant velocity time, and the deceleration time of the displaceable member, and the target value calculating means is capable of automatically dividing the movement time based on the time ratio.

In the foregoing manner, by automatically dividing the movement time using the time ratio of the acceleration time, the constant velocity time, and the deceleration time upon displacement of the displaceable member, a target value of a displacement amount or a displacement velocity of the displaceable member at any arbitrary timing can easily be obtained.

Further, the information related to the displacement velocity is a time ratio of the acceleration time, the constant velocity time, and the deceleration time of the displaceable member, and the target value calculating means determines a time ratio of the acceleration time, the constant velocity time, and the deceleration time, using at least two times from among the acceleration time, the constant velocity time, and the deceleration time, and automatically divides the movement time based on the time ratio.

In this manner, by using at least two times from among the acceleration time, the constant velocity time, and the deceleration time, one other of such times can be determined from the movement time of the displaceable member. As a result, the time ratio of the acceleration time, the constant velocity time, and the deceleration time can be calculated, and the movement time of the displaceable member can easily be divided.

Further, the information related to the displacement velocity comprises acceleration and deceleration of the displaceable member, and the target value calculating means may automatically divide the movement time by the acceleration and deceleration.

If the acceleration and deceleration when the displaceable member is displaced are preset, the constant velocity can be calculated from the movement velocity and the movement time. Further, since the acceleration time and the deceleration time when the displaceable member is displaced can also be calculated, the target value of the displacement amount or the displacement velocity of the displaceable member at any arbitrary timing can easily be obtained.

Furthermore, the information related to the displacement velocity comprises a constant velocity of the displaceable member, and the target value calculating means may automatically divide the movement time by the constant velocity.

If a constant velocity when the displaceable member is displaced is preset, then the constant velocity time of the displaceable member can be specified from the movement velocity and the movement time. Consequently, since the ratios of the acceleration time and the deceleration time can be determined from the constant velocity time and the movement time of the displaceable member, the target value of the displacement amount or the displacement velocity of the displaceable member at any arbitrary timing can easily be obtained.

The target value calculating means can be constituted to calculate the acceleration, the acceleration time, the constant velocity, the constant velocity time, the deceleration, and the deceleration time of the displaceable member respectively from the information related to the displacement velocity, the movement distance, and the movement time, and based on the calculation result thereof, is capable of calculating the target value of the displacement amount or the displacement velocity of the displaceable member at the arbitrary timing.

In this manner, by respectively calculating the acceleration, the acceleration time, the constant velocity, the constant velocity time, the deceleration, and the deceleration time of the displaceable member, detailed operations of the displaceable member can be determined, and the target value of the displacement amount or the displacement velocity of the displaceable member at any arbitrary timing can easily be obtained.

In addition, preferably, the drive control means controls driving of the actuator so that the displacement velocity changes in order through an acceleration phase, a constant velocity phase, and a deceleration phase, during one displacement of the displaceable member.

By providing a configuration in which, in one displacement of the displaceable member, the displacement velocity changes in order through an acceleration phase, a constant velocity phase, and a deceleration phase, the displaceable member can be displaced in accordance with basic operations, such that the displaceable member gradually accelerates when driving is started, at the intermediate time of driving thereof the displaceable member is displaced stably at a predetermined velocity, and when driving is halted, the displaceable member is stopped gently.

In this case, the target value calculating means may calculate the target value of the displacement amount or the displacement velocity of the displaceable member at the arbitrary timing, such that the acceleration time is shorter than the deceleration time.

By calculating the target value such that, in one displacement of the displaceable member, the acceleration time is shorter than the deceleration time, the displaceable member can be accelerated rapidly until reaching a constant velocity when driving of the actuator is started, the displaceable member can be decelerated gently as it approaches a predetermined position, and the displaceable member can be displaced more precisely to the predetermined position.

The drive control means may be constituted to drive the actuator by generating a drive signal based on the target value of the displacement amount or the displacement velocity of the displaceable member, and there may further be provided a specification data setting means for setting, as specification data of actuators made up from a plurality of types or models, specification data of the actuator, which is controlled, from a database in which at least one value is stored beforehand from among a resistance value, a thrust force constant, a weight of the displaceable member, and a stroke of the displaceable member, and a specification data gain adjustment means that transmits a gain adjustment signal for adjusting the drive signal generated in the drive control means, based on the specification data, which has been set.

In the foregoing manner, by making adjustments to the gain of the drive signal that controls driving of the actuator based on specification data including a resistance value, a thrust force constant, a weight of the displaceable member, and a stroke of the displaceable member, an optimal driving force can be transmitted to the displaceable member in accordance with specifications of the actuator. Accordingly, for example, in the case that the resistance value of the actuator, driving of which is actually being controlled, is higher in comparison with other actuators, adjustments can be made so that the drive signal sent to the actuator is increased.

Further, the drive control means may be constituted to control driving of the actuator by generating a drive signal based on the target value of the displacement amount or the displacement velocity of the displaceable member, and there may further be provided a workpiece information setting means for setting, as workpiece information for effecting a predetermined operation along with displacement of the displaceable member, a value of at least one of a weight, a posture, and a load, together with a workpiece information gain adjustment means that transmits a gain adjustment signal for adjusting the drive signal generated in the drive control means, based on the workpiece information, which has been set.

In the foregoing manner, by making adjustments to the gain of the drive signal that controls driving of the actuator based on information of the weight, posture and load of the workpiece, an optimal driving force can be transmitted to the displaceable member corresponding to information of the workpiece. Accordingly, for example, in the case that a heavy workpiece is transported by the displaceable member, adjustments can be made so that the drive signal or the driving force sent to the actuator can be increased.

Furthermore, the drive control means may be constituted to control driving the actuator by generating a drive signal based on the target value of the displacement amount or the displacement velocity of the displaceable member, and there may further be provided a movement information gain adjusting means that transmits a gain adjustment signal for adjusting the drive signal generated in the drive control means, based on the movement distance set by the movement distance setting means, or the movement time set by the movement time setting means.

In this manner, by making adjustments to the gain of the drive signal that controls driving of the actuator based on the movement distance or the movement time, an optimal driving force can be transmitted to the displaceable member corresponding to the movement distance or the movement time. For example, in the case that the movement distance of the displaceable member is long whereas the movement time thereof is short, overshooting in the drive signal can easily occur, leading to the possibility that the displaceable member cannot be displaced accurately to the predetermined position. In order to avoid the occurrence of this type of overshooting, etc., the movement information gain adjusting means is capable of performing adjustments to reduce the drive signal or the driving force sent to the actuator.

Still further, an operating mode setting means may be provided for setting any one of a plurality of operating modes, in the case that a plurality of operating modes, the acceleration time, the constant velocity time, and the deceleration time of which are different, are stored beforehand, wherein the target value calculating means calculates the target value of the displacement amount or the displacement velocity of the displaceable member at the arbitrary timing, based on the operating mode, which has been set.

By storing the operating modes, each of which have a different acceleration time, constant velocity time, and deceleration time, in the case that the user implements a control to drive the actuator, a desired operating mode can easily be selected from among the plurality of operating modes. In addition, in accordance with the selected operating mode, and the displacement distance and displacement time of the displaceable member, the target value of the displacement amount or the displacement velocity of the displaceable member at any arbitrary timing can easily be calculated.

In this case, a velocity of the displaceable member at the predetermined position may be set in the operating mode. By setting the velocity of the displaceable member at the predetermined position, after the displaceable member has been displaced to the predetermined position, a further drive control can be implemented to further displace the displaceable member.

Further, an external apparatus, which is capable of setting a plurality of operating modes, may be connected to the actuator drive control apparatus. The operating mode setting means may set the operating mode, which has been sent at a predetermined timing from the external apparatus, and the target value of the displacement amount or the displacement velocity of the displaceable member may be calculated based on the operating mode, which has been set.

In this manner, by setting the operating mode, which is sent at a predetermined timing from the external apparatus, and by calculating the target value of the displacement amount or the displacement velocity of the displaceable member based on the set operating mode, a plurality of operating modes may be carried out in succession, and the operation steps can significantly be reduced.

Further, for achieving the aforementioned objects, the present invention also provides an actuator drive control method for displacing a displaceable member of an actuator to a predetermined position, comprising a movement distance setting step of setting a movement distance of the displaceable member from a movement start point to the predetermined position, a movement time setting step of setting a movement time for the displaceable member to move from the movement start point to the predetermined position, a target value calculating step of automatically dividing the movement time into an acceleration time, a constant velocity time, and a deceleration time based on preset information related to a displacement velocity when the displaceable member is displaced, and of calculating a target value of a displacement amount or a displacement velocity of the displaceable member at an arbitrary timing based on the divided movement time and the movement distance, and a drive control step of displacing the displaceable member to the predetermined position by controlling driving of the actuator based on the target value of the displacement amount or the displacement velocity of the displaceable member.

In this case, the information related to the displacement velocity is a time ratio of the acceleration time, the constant velocity time, and the deceleration time of the displaceable member, and in the target value calculating step, the movement time may be automatically divided based on the time ratio.

Further, the information related to the displacement velocity is a time ratio of the acceleration time, the constant velocity time, and the deceleration time of the displaceable member, and in the target value calculating step, the time ratio of the acceleration time, the constant velocity time, and the deceleration time may be determined using at least two times from among the acceleration time, the constant velocity time, and the deceleration time, and the movement time may be automatically divided based on the time ratio.

Furthermore, the information related to the displacement velocity may comprise acceleration and deceleration of the displaceable member, and the target value calculating step may automatically divide the movement time by the acceleration and the deceleration.

Still further, the information related to the displacement velocity may comprise a constant velocity of the displaceable member, and the target value calculating step may automatically divide the movement time by the constant velocity.

In the target value calculating step, preferably, the acceleration, the acceleration time, the constant velocity, the constant velocity time, the deceleration, and the deceleration time of the displaceable member are calculated respectively from the information related to the displacement velocity, the movement distance, and the movement time, and based on a calculation result thereof, the target value of the displacement amount or the displacement velocity of the displaceable member is calculated at the arbitrary timing.

Further, in the drive control step, driving of the actuator is controlled so that the displacement velocity changes in order through an acceleration phase, a constant velocity phase, and a deceleration phase, during one displacement of the displaceable member.

In this case, in the target value calculating step, the target value of the displacement amount or the displacement velocity of the displaceable member at the arbitrary timing can be calculated such that the acceleration time is shorter than the deceleration time.

In the drive control step, a drive signal for controlling driving of the actuator is generated, based on the target value of the displacement amount or the displacement velocity of the displaceable member, and there may further be provided a specification data setting step of setting, as specification data of actuators made up from a plurality of types or models, specification data of the actuator, which is controlled, from a database in which at least one value is stored beforehand from among a resistance value, a thrust force constant, a weight of the displaceable member, and a stroke of the displaceable member, and a specification data gain adjustment step that transmits a gain adjustment signal for adjusting the drive signal generated in the drive control step, based on the specification data, which has been set.

Further, in the drive control step, a drive signal for controlling driving of the actuator is generated, based on the target value of the displacement amount or the displacement velocity of the displaceable member, and there may further be provided a workpiece information setting step of setting, as workpiece information for effecting a predetermined operation along with displacement of the displaceable member, a value of at least one of a weight, a posture, and a load, and a workpiece information gain adjustment step of transmitting a gain adjustment signal for adjusting the drive signal generated in the drive control step, based on the workpiece information, which has been set.

Furthermore, in the drive control step, a drive signal is generated for controlling driving of the actuator, based on the target value of the displacement amount or the displacement velocity of the displaceable member, and there may further be provided a movement information gain adjusting step of transmitting a gain adjustment signal for adjusting the drive signal generated in the drive control step, based on the movement distance set by the movement distance setting step, or the movement time set by the movement time setting step.

Still further, there may be provided an operating mode setting step of setting any one of a plurality of operating modes, in the case that a plurality of operating modes, the acceleration time, the constant velocity time, and the deceleration time of which are different, are stored beforehand, wherein, in the target value calculating step, the target value of the displacement amount or the displacement velocity of the displaceable member at the arbitrary timing is calculated, based on the operating mode, which has been set.

In this case, a velocity of the displaceable member at the predetermined position may be set in the plurality of operating modes.

Further, an external apparatus, which is capable of setting a plurality of operating modes, may be connected to the actuator drive control apparatus. The operating mode setting step may set the operating mode, which has been sent at a predetermined timing from the external apparatus, and the target value of the displacement amount or the displacement velocity of the displaceable member may be calculated based on the operating mode, which has been set.

According to the present invention, by setting the movement distance and the movement time of the displaceable member that constitutes the actuator, detailed operations of the displaceable member can be set, and the displaceable member can be displaced with high precision. Owing thereto, since the user is not required to calculate detailed driving conditions such as the velocity of the displaceable member, the time at the velocity, and the like, the work burden on the user can significantly be lessened, and malfunctions caused by human error can be avoided.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing an actuator drive control apparatus, an actuator, and a computer according to an embodiment of the present invention;

FIG. 2 is a graph for explaining a target value of a displacement amount or a displacement velocity of a displaceable member in accordance with a first operating mode;

FIG. 3 is a graph for explaining a target value of a displacement amount or a displacement velocity of a displaceable member in accordance with a second operating mode;

FIG. 4A is a graph showing the relationship between time and velocity, which is descriptive of another method for calculating the target value of a displacement velocity of the displaceable member;

FIG. 4B is a graph showing the relationship between time and velocity, which is descriptive of another method for calculating the target value of a displacement velocity of the displaceable member;

FIG. 5 is a flowchart showing a process sequence upon displacement of the displaceable member by the actuator drive control apparatus; and

FIG. 6 is a flowchart showing a process sequence upon implementation of gain adjustment with respect to a drive signal.

### DESCRIPTION OF THE PREFERRED EMBODIMENT

Below, an actuator drive control apparatus 10 and an actuator drive control method according to the present invention shall be described in detail with reference to the accompanying drawings.

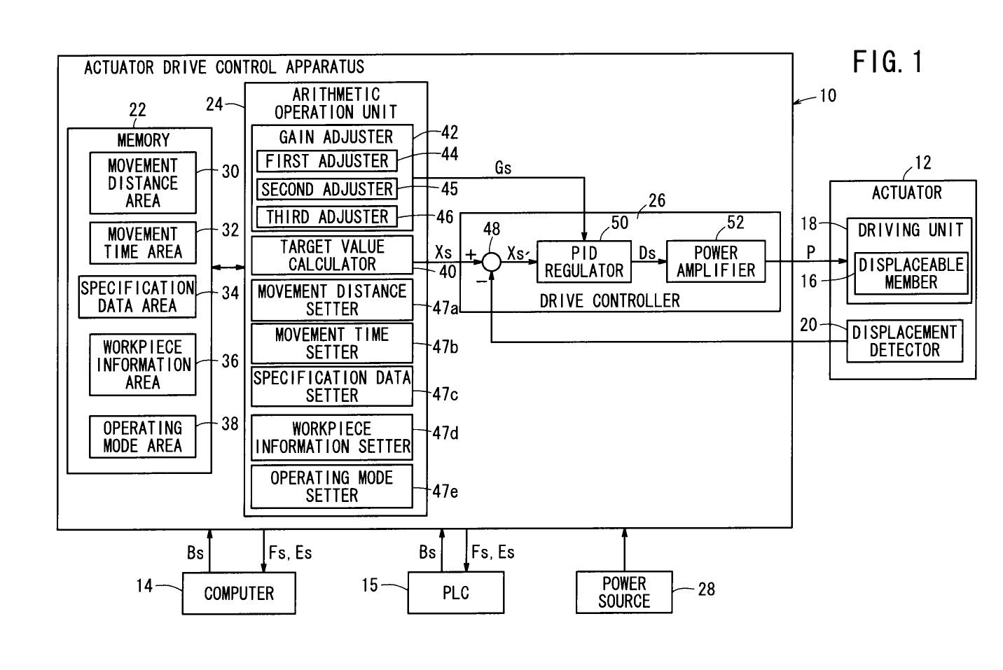

As shown in FIG. 1, the actuator drive control apparatus 10 according to an embodiment of the present invention is connected via cables to an actuator 12 and a computer 14, and a PLC (programmable logic controller) 15. A user performs control commands to input data or initiate driving to the actuator drive control apparatus 10 from the computer 14 (or the PLC 15), and in accordance therewith, the actuator drive control apparatus 10 implements controls to drive the actuator 12.

The actuator 12 includes a displaceable member 16, which is linearly displaceable in accordance with drive controls, a driving unit 18 for transmitting a driving force to the displaceable member 16, and a displacement detector 20 for detecting a displacement amount of the displaceable member 16.

The driving unit 18, which acts as a mechanism for transmitting a driving force to the displaceable member 16, can be applied, for example, to a linear motor, which causes the displaceable member 16 to slide (be displaced) linearly through a coil and permanent magnets. Corresponding to the electrical energy of driving power supplied from the actuator drive control apparatus 10, the driving unit 18 converts the electromagnetic force generated in the coil, and controls a displacement amount and displacement velocity of the displaceable member 16 proportional to the electromagnetic force. Further, in accordance with a switching signal from the actuator drive control apparatus 10, the linear movement direction (advancing, retracting) of the displaceable member 16 can be switched. Further, apart therefrom, as the driving unit 18, there may also be applied a servomotor, such as a stepping motor, a brush-equipped DC motor, a brushless DC motor, or the like, which is constituted to transmit a rotary driving force of the motor to the displaceable member 16.

By transmitting a driving force of the driving unit 18 as described above, the displaceable member 16 is made linearly displaceable (in a direction guided by guide members or the like). As the displaceable member 16, a structure can be provided made up from a stage (slide table) on which a workpiece can be loaded, or alternatively, a piston or the like that presses the workpiece.

On the other hand, the displacement detector 20 of the actuator 12 detects the displacement velocity of the displaceable member 16, and feeds back to the actuator drive control apparatus 10 the detection value thereof. The displacement velocity detection value of the displaceable member 16, for example, can be obtained by attaching a displacement sensor to the displaceable member 16 and detecting a displacement amount along with an elapsed time, whereby the displacement velocity detection value is then determined from the detected displacement amount and the elapsed time. The actuator drive control apparatus 10 can correct the drive signal (drive power) supplied to the driving unit 18 based on the detected value to thereby perform feedback control on the displacement of the displaceable member 16. In the case that a servomotor is applied to the driving unit 18, the displacement detector 20 can utilize an encoder, a resolver or the like. Further, the displacement detector 20 may be disposed separately from the actuator 12.

By constructing the actuator 12 in the foregoing manner, drive control is performed on the driving unit 18, and the displacement amount and displacement velocity of the displaceable member 16 are controlled by the actuator drive control apparatus 10, which is connected thereto. Owing thereto, for example, in a condition where the main body of the actuator 12 is fixed, the displaceable member 16 is capable of being positioned (displaced) with high precision to a predetermined position (target position).

The actuator drive control apparatus 10 according to the embodiment is applied to an actuator 12 that displaces a displaceable member 16 by a linear motor. However, the actuator 12, which is to be controlled, is not limited. For example, a displacement mechanism, which displaces the displaceable member 16 by means of an electric cylinder or a ball screw, can be connected to the actuator drive control apparatus 10 and a drive control can be implemented thereon.

The actuator drive control apparatus 10 comprises, in the interior of an apparatus main body (not shown), a memory 22, an arithmetic operation unit 24, and a drive controller 26. Further, electrical power (from a DC power source) 28 is supplied from the exterior of the apparatus main body.

The memory 22 is constituted by a ROM and a RAM. Essential control programs for controlling driving of the actuator 12 are stored beforehand in the ROM, and plural data regions for storing therein data that is used to control driving of the actuator 12 are allocated to respective address spaces of the RAM. More specifically, as data regions of the memory 22, there are provided a movement distance area 30, a movement time area 32, a specification data area 34, a workpiece information area 36, and an operating mode area 38. Further, the displacement position, etc., of the displaceable member 16 when the displaceable member 16 is displaced also is stored in the memory 22.

Among such areas, the data, which is input from the user through the computer 14, is stored in the movement distance area 30, the movement time area 32, and the workpiece information area 36. More specifically, movement distance data indicative of the distance (displacement amount) that the displaceable member 16 moves from a movement start point until reaching a predetermined position is stored in the movement distance area 30. Further, movement time data indicative of the time over which the displaceable member 16 moves from the movement start point to the predetermined position is stored in the movement time area 32. Further, as information of an object (workpiece) on which the displaceable member 16 performs actions such as transporting or pressing the object, the weight, posture, and load, etc., thereof are stored in the workpiece information area 36. The user, prior to controlling driving of the actuator 12, inputs a desired movement distance and a desired movement time of the displaceable member 16, or information (weight, posture, load, etc.) of the workpiece that is transported or pressed by the displaceable member 16. Owing thereto, when driving of the actuator 12 is controlled, the displacement distance, displacement time, and workpiece information for the displaceable member 16 are set, and each of such stored data are read by the arithmetic operation unit 24. In the event that transportation or pressing of the workpiece is not performed by the displaceable member 16, or in the case that almost no influence is imparted by the workpiece with respect to the displacement of the displaceable member 16, the workpiece information may not be set. Further, setting of the workpiece information (weight, posture, load, etc.) need not solely be set by the user, but rather, a structure may be provided in which a sensor is incorporated in the actuator 12, and workpiece information may be detected using such a sensor.

On the other hand, as specification data of actuators 12 made up from multiple types or models, a resistance value, a thrust constant, the weight of the displaceable member 16, the stroke of the displaceable member 16, etc., are stored beforehand in the specification data area 34. The user, prior to controlling driving of the actuator 12, selects the type or model of the actuator 12 that actually is controlled from a database that is stored in the specification data area 34. Owing thereto, specification data of the actuator 12 is set, and the specification data is read by the arithmetic operation unit 24. Specification data of the actuator 12 may not be selected solely by the user, but automatic selection thereof may also be carried out. More specifically, a configuration may be provided in which unique identifying information of actuators made up from multiple types or models may be set in the actuator 12, and by connecting the actuator 12 to the actuator drive control apparatus 10, such identifying information is automatically read to thereby store the information in the specification data area 34.

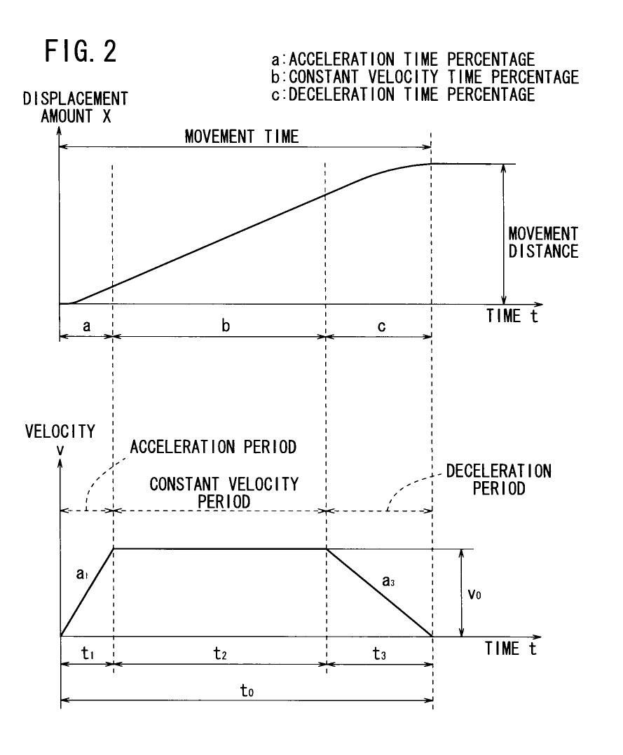

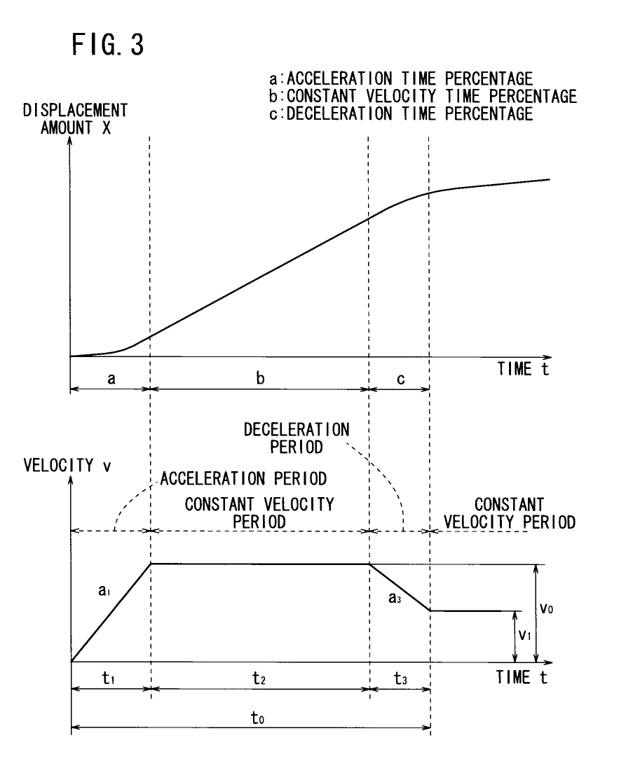

Further, data of operating modes, which are patterned from target values of a displacement amount or a displacement velocity of the displaceable member 16 at any arbitrary timing, are stored in plurality beforehand in the operating mode area 38. The operating mode is defined as a displacement (operation) pattern of the displaceable member 16 during drive control of the actuator 12. For example, as shown in FIGS. 2 and 3, various operating modes can be stored, such as operating modes in which time ratios of an acceleration time, a constant velocity time, and a deceleration time are different, or operating modes in which the velocity of the displaceable member differs at predetermined positions, etc.

FIGS. 2 and 3 schematically illustrate a relationship between time and a displacement amount (upper graph) and between time and velocity (lower graph) of the displaceable member 16. To explain in detail the operating modes shown in FIGS. 2 and 3, the operating mode shown in FIG. 2 (hereinafter referred to as a first operating mode) is a displacement pattern in which the displaceable member 16 is driven one time to be displaced (moved) to a predetermined position. In this case, the displaceable member 16 is accelerated from a condition in which operation thereof initially is stopped, when a constant velocity is reached the velocity is maintained for a predetermined time, and then the displaceable member 16 is decelerated (negative acceleration) upon approaching a target position, until ultimately the displaceable member 16 is stopped at the predetermined position.

On the other hand, the operating mode shown in FIG. 3 (hereinafter referred to as a second operating mode) is a displacement pattern in which, after the displaceable member 16 has been displaced to a predetermined position, the displaceable member 16 is displaced further at a constant velocity. For example, the second operating mode may be selected for a case in which a workpiece is mounted in a predetermined position, and after the displaceable member has been displaced to the predetermined position, the displaceable member 16 is operated to push out the workpiece at an arbitrary velocity.

Further, even in the first and second modes, if the ratios of the acceleration time (hereinafter referred to as an “acceleration period”), the constant velocity time (hereinafter referred to as a “constant velocity period”), and the deceleration time (hereinafter referred to as a “deceleration period”) are changed, the displacement pattern of the displaceable member 16 also is changed, and therefore, preferably, a plurality of operating modes, in which the time ratios of each of such periods are different, are prepared. Alternatively, the time ratios of each of such periods may be set by the user. Owing thereto, when driving of the actuator 12 is controlled, it is possible to displace the displaceable member 16 in greater detail over time.

Before driving of the actuator 12 is controlled, the user selects a desired operating mode from among the plurality of operating modes stored in the operating mode area 38. Thus, the selected operating mode is set, and the set operating mode is read by the arithmetic operation unit 24. As shown in FIGS. 2 and 3, the plural operating modes to be selected by the user preferably are displayed on a monitor (not shown) of the computer 14 as graphs in which a relationship between time and displacement amount, or a relationship between time and velocity is patterned. By displaying the operating modes in this manner, the user can easily select an operating mode that satisfies desired goals.

Even if operating modes are not selected as described above, the actuator drive control apparatus 10 may be constituted to calculate target values of the displacement amount or the displacement velocity of the displaceable member 16 in accordance with a preset basic operating mode (e.g., the first operating mode).

Returning to FIG. 1, the arithmetic operation unit 24 can be constituted using a microcomputer or the like, which reads out data from the memory 22 and carries out arithmetic processing thereon, and transmits control instruction signals (displacement control command signal X_{S}, gain adjustment signal G_{S}) to the drive controller 26 for controlling driving of the actuator 12. In the arithmetic operation unit 24, there are provided a target value calculator (target value calculation means) 40, a gain adjuster (gain adjustment means) 42, a movement distance setter (movement distance setting means) 47a, a movement time setter (movement time setting means) 47b, a specification data setter (specification data setting means) 47c, a workpiece information setter (workpiece information setting means) 47d, and an operating mode setter (operating mode setting means) 47e.

The target value calculator 40 reads out movement distance data of the displaceable member 16 from the movement distance area 30, and reads out movement time data of the displaceable member 16 from the movement time area 32. In addition, based on the read-out movement distance data and the read-out movement time data, an acceleration, an acceleration time, a constant velocity, a constant velocity time, a deceleration, and a deceleration time are calculated respectively, and from the calculation results thereof, a target value of the displacement amount or the displacement velocity of the displaceable member 16 is calculated at an arbitrary timing.

An acceleration a₁, an acceleration time t₁, a constant velocity v₀, a constant velocity time t₂, a deceleration a₃, and a deceleration time t₃, which are calculated in the target value calculator 40, make up essential parameters, which are needed to displace the displaceable member 16 with high precision. More specifically, ordinarily, in the event that the actuator 12 displaces the displaceable member 16, after initiation of driving, from a stopped condition, the displaceable member 16 is accelerated until it reaches a constant velocity, after reaching a predetermined velocity, the displaceable member 16 is displaced at the constant velocity, and thereafter, the displaceable member 16 is decelerated from a moving condition until the displaceable member 16 is stopped (refer to the first operating mode shown in FIG. 2). Accordingly, by calculating the acceleration a₁, the acceleration time t₁, the constant velocity v₀, the constant velocity time t₂, the deceleration a₃, and the deceleration time t₃, all of the displacement velocities and the displacement times in succession, which are required during displacement of the displaceable member, can be determined. As a result, target values of the displacement amount or the displacement velocity at any arbitrary timing can easily be determined.

Target values of the displacement amount or the displacement velocity of the displaceable member 16 at an arbitrary timing, which were calculated in the target value calculator 40, may be displayed on a monitor or the like of the computer 14, for example, in the form of a graph as shown in FIGS. 2 and 3. A method for calculating target values of the displacement amount or the displacement velocity of the displaceable member 16 at any arbitrary timing (graph formation method) shall be described later.

The target values of the displacement amount or the displacement velocity of the displaceable member 16 at any arbitrary timing, which are calculated by the target value calculator 40, are transmitted continuously over time to the drive controller 26 as displacement control command signals X_{S}.

The gain adjuster 42 comprises a first adjuster (specification data gain adjustment means) 44 that reads specification data from the specification data area 34 pertaining to the actuator 12 selected by the user, a second adjuster (workpiece information gain adjustment means) 45 for reading from the workpiece information area 36 information (workpiece information data) of the workpiece input by the user, and a third adjuster (movement information gain adjustment means) 46 for reading movement distance data and movement time data from the movement distance area 30 and the movement time area 32. The gain adjuster 42 generates gain adjustment signals G_{S} for changing voltage or current values of the drive signal in the drive controller 26.

For example, in the case that the resistance value of the actuator 12 presently being drive controlled is high in comparison to other actuators, the drive voltage needed to control driving of the actuator 12 becomes insufficient and the displaceable member 16 cannot be displaced accurately to a predetermined position. Accordingly, in the first adjuster 44, based on the resistance value from the specification data of the actuator 12, which is read out, a first adjustment signal is generated for increasing the drive signal value that is sent to the actuator 12. Conversely, in the case that the resistance value of the actuator 12 presently being drive-controlled is low in comparison to other actuators, a first adjustment signal is generated for decreasing the drive signal value sent to the actuator 12.

Further, for example, in the case that the workpiece transported by the displaceable member 16 is heavy, because a load is imposed on the displaceable member 16, the displaceable member 16 cannot be displaced accurately to a predetermined position. Accordingly, in the second adjuster 45, based on the weight of the workpiece, which is read out, a second adjustment signal is generated for increasing the drive signal value that is sent to the actuator 12. Conversely, in the case that the weight of the workpiece is comparatively light, a second adjustment signal is generated for decreasing the drive signal value sent to the actuator 12.

Furthermore, in the case that the movement distance of the displaceable member 16 is long whereas the movement time thereof is short, it is easy for overshooting in the drive signal to occur, and there is a possibility that the displaceable member 16 cannot be displaced accurately to a predetermined position. Accordingly, in the third adjuster 46, based on the movement distance and the movement time of the displaceable member 16, which are read out, a third adjustment signal is generated for decreasing the drive signal value that is sent to the actuator 12. Conversely, in the case that the movement distance of the displaceable member 16 is short whereas the movement time thereof is long, a third adjustment signal is generated for increasing the drive signal value sent to the actuator 12 so as to displace the displaceable member 16 reliably.

The first through third adjustment signals generated by the first through third adjusters 44, 45, 46 are integrated in the gain adjuster 42, and are transmitted to the drive controller 26 as a gain adjustment signal G_{S}. It is a matter of course that the gain adjuster 42 may also generate the gain adjustment signal G_{S} based on various causes that impart an influence on displacement of the displaceable member 16, apart from specification data of the actuator 12, information of the transported workpiece, the movement distance, or the movement time. Further, the actuator drive control apparatus 10 can implement drive control of the actuator 12 without carrying out gain adjustments.

On the other hand, each of the setters 47a to 47e of the arithmetic operation unit 24 includes a function to store the respective control data, which are input or selected from the computer 14, in the respective areas of the memory 22. More specifically, the movement distance setter 47a stores movement distance data input from the user via the computer 14 in the movement distance area 30, and similarly, the movement time setter 47b stores movement time data input from the user in the movement time area 32. Further, the specification data setter 47c stores specification data of the actuator 12 selected by the user via the computer 14 in the specification data area 34. Further, the workpiece information setter 47d stores workpiece information data input from the user in the workpiece information area 36. Still further, the operating mode setter 47e stores the operating mode selected by the user in the operating mode area 38.

The drive controller 26 in the actuator drive control apparatus 10 comprises a computing unit 48, a PID regulator 50, and a power amplifier 52. Based on the displacement control command signal X_{S} and the gain adjustment signal G_{S} transmitted by the arithmetic operation unit 24, driving power P is generated for controlling the actuator 12.

The computing unit 48 can be constituted, for example, from circuits such as operational amplifiers or the like, such that by negatively feeding back the detecting value (feedback signal) transmitted from the displacement detector 20 of the actuator 12, corrections can be performed on the displacement control command signal X_{S} output from the target value calculator 40. Owing thereto, the actuator drive control apparatus 10 according to the present embodiment can carry out a feedback control on the driving (i.e., displacement of the displaceable member 16) of the actuator 12.

The PID regulator 50 is disposed on the output side of the computing unit 48, and a corrected displacement control command signal X_{S}′ output from the computing unit 48 is input thereto. In the PID regulator 50, a proportional control is implemented to cause the corrected displacement control command signal X_{S}′ to approximate the drive signal D_{S}, in accordance with the target value of the displacement velocity of the displaceable member 16, and together therewith, by means of a derivative control, integral control or the like, the drive signal D_{S} is stabilized and then output to the power amplifier 52.

Further, the PID regulator 50, by inputting the gain adjustment signal G_{S} transmitted from the gain adjuster 42, performs an adjustment on the drive control signal (voltage value or current value) based on the gain adjustment signal G_{S}. Owing thereto, a drive signal D_{S} output from the PID regulator 50 acquires a signal value that is optimal corresponding to the specification data of the actuator 12 to be controlled, workpiece information of the workpiece that is transported or pressed, and the movement distance and movement time of the displaceable member 16.

The power amplifier 52 is constituted by a voltage amplifying circuit and a current amplifying circuit, and amplifies the voltage and current of the drive signal D_{S}, which is output from the PID regulator 50, and then supplies the same as driving power P to the actuator 12. The actuator 12 is capable of controlling driving of the driving unit 18 by the supplied driving power P, and of displacing the displaceable member 16. The power amplifier 52 need not be disposed inside the actuator drive control apparatus 10, but may be disposed external to the power amplifier 52.

Further, in the present embodiment, although a structure is provided in which driving power P is supplied to the actuator 12 by the actuator drive control apparatus 10, the actuator 12 can be constituted to include a power source unit to which power is supplied directly from the exterior without going through the actuator drive control apparatus 10. In this case, the actuator drive control apparatus 10 may be constituted to send the drive signal D_{S}′, which controls the supplied power with respect to the actuator 12, to thereby control the electric energy of the power supplied from the exterior.

For the computer 14, which is connected to the actuator drive control apparatus 10, a general-purpose computer can be used, which is equipped with a CPU, a memory, a keyboard, a monitor, and the like (not shown). A program for controlling the actuator 12 is stored in the computer 14, and when the program is executed, an actuator control input screen is displayed on the monitor. From the input screen, the user inputs movement distance data, movement time data of the displaceable member 16, and workpiece information data, and together therewith, selects an actuator 12 to be controlled, and additionally selects the operating mode for the displaceable member 16. Various data input by the input screen are sent to the actuator drive control apparatus 10 and such data are stored in the respective areas of the memory 22.

The PLC 15 is connected with respect to the actuator drive control apparatus 10, so as to carry out parallel transmission and reception of signals, etc., to select signals or optional step data to control driving of the actuator 12. The step data is data to simplify the operating mode of the displaceable member 16, including information of movement distance data (or predetermined position data) and movement time data of the displaceable member 16. In this case, the PLC 15 is capable of simultaneously transmitting the signals to select the step data and the signals to control driving of the actuator 12, and can thereby simplify drive control of the actuator 12. Further, the PLC 15 also is capable of simultaneously transmitting the step data, for example, 4-bit step data.

When driving of the actuator 12 is controlled, by transmitting a drive initiation signal B_{S} from the computer 14 (or PLC 15) to the actuator drive control apparatus 10, drive control of the actuator 12 is initiated. Further, when drive control of the actuator is concluded, a drive completion signal F_{S} is sent to the computer 14 (or PLC 15) from the actuator drive control apparatus 10. Furthermore, in the case that an error occurs while driving of the actuator 12 is being controlled, a drive error signal E_{S} is sent to the computer 14 (or PLC 15) from the actuator drive control apparatus 10.

The signals that are transmitted and received by the actuator drive control apparatus 10 and the computer 14 (or PLC 15) are not limited solely to the drive initiation signal B_{S}, the drive completion signal F_{S}, and the drive error signal E_{S}. For example, information of the present position of the displaceable member 16, the displacement velocity of the displaceable member 16, and the current amount of the drive power output to the actuator 12, etc., can be sent to the computer 14 from the actuator drive control apparatus 10 and be displayed on the monitor of the computer 14. Further, a signal for turning OFF movement of the displaceable member 16, a signal for turning ON movement of the displaceable member 16 in the vicinity of the predetermined position, a signal that turns ON in the vicinity of the target value of the displacement velocity of the displaceable member 16, and a signal that turns OFF in the vicinity of the target thrust force of the displaceable member 16, etc., can be output from the computer 14.

Furthermore, in the case that the PLC 15 is used, the movement distance data (or the predetermined position data) and the movement time data can be set by the PLC 15 as plural step data. For example, when the user selects plural step data from within the PLC 15, the selected plural step data is sent from the PLC 15 to the actuator drive control apparatus 10, whereby the movement distance data and the movement time data are stored in the movement distance area 30 and the movement time area 32 individually for each item of step data. In this case, the actuator drive control apparatus 10 makes multiple calculations of target values for the displacement amount or displacement velocity of the displaceable member 16, based on the plural step data (movement distance and movement time). Additionally, under a condition in which specified step data (target values) are selected, drive control of the actuator 12 can be initiated by sending signals from the PLC 15 to control driving of the actuator 12.

Still further, the actuator drive control apparatus 10 and the PLC 15 may be connected together mutually by a serial transmission connecting cable. More specifically, step data is transmitted by serial transmission from the PLC 15 to the actuator drive control apparatus 10. In the case that serial transmission is utilized in this manner, transmission of the signals (data) described below and drive control of the actuator 12 can be performed.

More specifically, with the PLC 15, during the setting stage, a plurality of step data (operating modes) and the order of operation (driving control) thereof are set beforehand, such that prior to driving of the actuator 12, and based on the order in which the actuator 12 is to be driven, a single item of step data is sent by serial transmission. The operating mode setter 47e of the actuator drive control apparatus 10 stores the step data in the memory 22 (e.g., in the operating mode area 38). In addition, when the drive start signal B_{S} is received by serial transmission, the actuator drive control apparatus 10 (the target value calculator 40) calculates a target value of the displacement amount or the displacement velocity of the displaceable member 16 based on the stored step data, and control (displacement of the displaceable member 16) of the actuator 12 is carried out. Further, during driving (or after driving) of the actuator 12, the PLC 15 sends the next item of step data, which in turn is stored in the actuator drive control apparatus 10, whereupon the actuator drive control apparatus 10 calculates a target value of the displacement amount or the displacement velocity of the displaceable member 16 based on the next item of step data, and drive control of the actuator 12 can be performed again.

With the above-described structure, even if the step data is transmitted from the PLC 15 by serial transmission, deterioration of the overall operating time of the actuator 12 can be suppressed. Further, it is not necessary to select the step data at the end of every movement of the displaceable member 16. Therefore, operational processes can be significantly reduced, and driving control by the actuator drive control apparatus 10 can smoothly be performed.

Further, because an inexpensive cable, which is less expensive than cables used for parallel transmission, can be used as the serial transmission connecting cable, costs can be reduced. Furthermore, during serial transmission, because the actuator drive control apparatus 10 and the PLC 15 can easily be connected through a single connecting cable, the amount of wiring can be minimized. In particular, in the case that drive control of multiple actuators 12 is to be implemented, by reducing the number of wires and cables that are used, wiring between each of the actuators 12 can easily be performed.

The actuator drive control apparatus 10, the actuator 12, and the computer 14 (or the PLC 15) according to the embodiment of the present invention basically are constructed as described above. Next, an explanation shall be made concerning the target value of the displacement amount or the displacement velocity of the displaceable member 16 at any arbitrary timing, which is calculated by the target value calculator 40, for a case in which drive control of the actuator 12 actually is implemented.

As noted already, in the actuator drive control apparatus 10, as shown in FIGS. 2 and 3, a plurality of operating modes are stored in the operating mode area 38. By the user selecting one of the operating modes, the displacement amount or the displacement velocity over time of the displaceable member 16 can easily be set.

Prior to performing an operation to displace the displaceable member 16, a drive control is performed to move the displaceable member to a movement start point. For example, the movement start point can be an origin position (e.g., a stroke end of the actuator 12, or an origin signal position of an incorporated displacement sensor), which is set beforehand in the actuator 12. Displacement to the origin position of the displaceable member 16 by the actuator drive control apparatus 10 may be implemented through a control, which is similar to that used when the displaceable member 16 is displaced to a predetermined position in accordance with the first operating mode.

Further, if a configuration is provided in which the displacement position of the displaceable member 16 in the previous displacement is capable of being stored in the memory 22, then the actuator drive control apparatus 10 can be moved to the movement start point set by the user based on the previous displacement position. More specifically, with a movement start point at a position different from the origin position, after the user has input the position of the movement start point, a distance to the movement start point may be calculated from the previous displacement position, and the displaceable member 16 can be displaced to the movement start point based on the calculated movement distance.

After the displaceable member 16 has been displaced to the movement start point, responsive to the operating mode selected by the user, the target value of the displacement amount or the displacement velocity of the displaceable member 16 at an arbitrary timing is calculated. Explanations shall now be made concerning calculation methods according to the present embodiment, for calculating target values in the first operating mode shown in FIG. 2 and the second operating mode shown in FIG. 3.

The target value calculator 40 is programmed to automatically divide the movement time into an acceleration time, a constant velocity time, and a deceleration time, based on information pertaining to the displacement velocity when the displaceable member 16 is displaced. In the case that the information pertaining to the displacement velocity is defined by a time ratio of the acceleration time, the constant velocity time, and the deceleration time, such that a (acceleration time percentage): b (constant velocity time percentage): c (deceleration time percentage), when the first operating mode is selected, the movement time t₀, which is read out from the movement time area 32, is divided based on the time ratio a:b:c of each of the velocities, which are set for that operating mode. In this case, based on the movement time t₀, the acceleration time t₁ can be calculated using equation (1), the constant velocity time t₂ can be calculated using equation (2), and the deceleration time t₃ can be calculated using equation (3), as shown below.

t₁=a·t₀/(a+b+c) (1)

t₂=b·t₀/(a+b+c) (2)

t₃=c·t₀/(a+b+c) (3)

In this manner, by calculating the acceleration time t₁, the constant velocity time t₂, and the deceleration time t₃ when the displaceable member 16 is displaced using the time ratio a:b:c, in accordance with the above equations (1) through (3), the movement time t₀ can be divided automatically.

In the case that information concerning the displacement velocity is given by the acceleration time t₁, the constant velocity time t₂, and the deceleration time t₃ of the displaceable member 16, if at least two times from among each of such times are set beforehand, since the other one of such times can be determined from the total movement time t₀ of the displaceable member 16, the time ratio a:b:c of the acceleration time t₁, the constant velocity time t₂, and the deceleration time t₃ can easily be calculated. Accordingly, in this case as well, the movement time t₀ of the displaceable member 16 can easily be divided.

Further, during drive control of the actuator 12, the acceleration a₁, the constant velocity v₀ (the acceleration a₂ of the constant velocity period is zero because the velocity at this period is constant), and the deceleration a₃, which are essential parameters when the displaceable member 16 is displaced, can be determined by the following computational expressions of Expression 1, as shown below.

$$\begin{matrix}{S}_{1} = \frac{1}{2} \cdot \frac{a}{a + b + c} \cdot {t}_{0} \cdot {v}_{0} & ( 4 ) \\ {S}_{2} = \frac{b}{a + b + c} \cdot {t}_{0} \cdot {v}_{0} & ( 5 ) \\ {S}_{3} = \frac{1}{2} \cdot \frac{c}{a + b + c} \cdot {t}_{0} \cdot {v}_{0} & ( 6 ) \\ S = {S}_{1} + {S}_{2} + {S}_{3} = \frac{a + 2 b + c}{a + b + c} \cdot \frac{{t}_{0} \cdot {v}_{0}}{2} & ( 7 ) \\ {v}_{0} = \frac{a + b + c}{a + 2 b + c} \cdot \frac{2 S}{{t}_{0}} & ( 8 ) \\ {a}_{1} = {v}_{0} / ( \frac{a}{a + b + c} \cdot {t}_{0} ) = \frac{a + b + c}{a} \cdot \frac{{v}_{0}}{{t}_{0}} & ( 9 ) \\ {a}_{1} = \frac{{( a + b + c )}^{2}}{( a + 2 b + c ) a} \cdot \frac{2 S}{{t}_{0}^{2}} & ( 10 ) \\ {a}_{3} = - \frac{a + b + c}{c} \cdot \frac{{v}_{0}}{{t}_{0}} & ( 11 ) \\ {a}_{3} = - \frac{{( a + b + c )}^{2}}{( a + 2 b + c ) c} \cdot \frac{2 S}{{t}_{0}^{2}} & ( 12 )\end{matrix}$$

As shown in Expression 1, the movement distance S₁ of the displaceable member 16 during the acceleration period can be calculated by the above equation (4), the movement distance S₂ of the displaceable member 16 during the constant velocity period can be calculated by the above equation (5), and the movement distance S₃ of the displaceable member 16 during the deceleration period can be calculated by the above equation (6).

Further, the total movement distance (displacement amount) S when the displaceable member 16 is displaced to the predetermined position is given by S₁+S₂+S₃. Thus, as shown in the above equation (7), the movement distance S can be determined by adding together equations (4), (5) and (6). Furthermore, by converting the form of equation (7) into the above equation (8), an equation results that enables the constant velocity v₀ to be determined, and thus, by substituting therein the movement distance data read out from the movement distance area 30, the constant velocity v₀ can also be calculated.

Further, the acceleration a₁ during the acceleration period can be represented by the above equation (9). Accordingly, by substituting therein the constant velocity v₀ determined in equation (8), the acceleration a₁ can be calculated.

Similarly, the deceleration a₃ during the deceleration period can be represented by the above equation (11). By substituting the constant velocity v₀ into the above equation (12), which is converted from equation (11), the deceleration a₃ can be calculated.

In the foregoing manner, during the first operating mode in which the displaceable member 16 is displaced (moved) to the predetermined position in one driving thereof, the target value calculator 40 is capable of easily calculating values of the acceleration a₁, the acceleration time t₁, the constant velocity v₀, the constant velocity time t₂, the deceleration a₃, and the deceleration time t₃.

Owing thereto, in the target value calculator 40, based on each of the above calculated values, a graph (refer to the upper side of the graph in FIG. 2) made up from a relationship between the movement time and the displacement amount of the displaceable member 16, or a graph (refer to the lower side of the graph in FIG. 2) made up from a relationship between the movement time and the displacement velocity of the displaceable member 16 can be formed. Thus, a target value of the displacement amount or the displacement velocity of the displaceable member 16, which is to be drive controlled, can be obtained at any arbitrary timing of the first operating mode.

Moreover, in the first operating mode, by calculating the target value such that the acceleration time t₁ is shorter than the deceleration time t₃, the displaceable member 16 can be accelerated rapidly until reaching the constant velocity v₀ when driving of the actuator 12 is started, and the displaceable member 16 can be decelerated gently as it approaches the vicinity of the predetermined position. Owing thereto, the displaceable member 16 can be moved more precisely to the predetermined position.

Further, when the second operating mode shown in FIG. 3 is selected, the target value calculator 40 can calculate the acceleration time t₁, the constant velocity time t₂, and the deceleration time t₃ by the above equations (1), (2) and (3), in the same manner as in the first operating mode, based on the time ratio a:b:c of the acceleration time t₁, the constant velocity time t₂, and the deceleration time t₃, which are set for the operating mode.

Further, during drive control of the actuator 12, the acceleration a₁, the constant velocity v₀, and the deceleration a₃, which are essential parameters when the displaceable member 16 is displaced, can be determined by the following computational expressions of Expression 2, shown below.

$$\begin{matrix}{S}_{3} = \frac{c}{a + b + c} ( {v}_{0} + {v}_{1} ) \cdot \frac{{t}_{0}}{2} & ( 13 ) \\ \begin{matrix}S = {S}_{1} + {S}_{2} + {S}_{3} \\ = \frac{a + 2 b + c}{a + b + c} \cdot \frac{{v}_{0} \cdot {t}_{0}}{2} + \frac{c}{a + b + c} \cdot \frac{{v}_{1} \cdot {t}_{0}}{2}\end{matrix} & ( 14 ) \\ \begin{matrix}{v}_{0} = \frac{a + b + c}{a + 2 b + c} \cdot \frac{S - \frac{c}{a + b + c} \cdot \frac{{v}_{1} \cdot {t}_{0}}{2}}{\frac{{t}_{0}}{2}} \\ = \frac{a + b + c}{a + 2 b + c} \cdot \frac{2 S}{{t}_{0}} - \frac{c}{a + 2 b + c} \cdot {v}_{1}\end{matrix} & ( 15 ) \\ \begin{matrix}{a}_{1} = \frac{a + b + c}{a} \cdot \frac{{v}_{0}}{{t}_{0}} \\ = \frac{{( a + b + c )}^{2}}{a ( a + 2 b + c )} \cdot \frac{2 S}{{t}_{0}^{2}} - \frac{c ( a + b + c )}{a ( a + 2 b + c )} \cdot \frac{{v}_{1}}{{t}_{0}}\end{matrix} & ( 16 ) \\ {a}_{3} = - \frac{a + b + c}{c} \cdot \frac{( {v}_{0} - {v}_{1} )}{{t}_{0}} & ( 17 ) \\ {a}_{3} = - \frac{{( a + b + c )}^{2}}{c ( a + 2 b + c )} \cdot \frac{2 S}{{t}_{0}^{2}} - \frac{( a + b + c ) ( a + 2 b + 2 c )}{c ( a + 2 b + c )} \cdot \frac{{v}_{1}}{{t}_{0}} & ( 18 )\end{matrix}$$

As shown in Expression 2, the movement distance S₁ of the displaceable member 16 during the acceleration period can be calculated from equation (4) in Expression 1, and the movement distance S₂ of the displaceable member 16 during the constant velocity period can be calculated by equation (5) in Expression 1. On the other hand, the movement distance S₃ of the displaceable member 16 during the deceleration period can be calculated by the above equation (13). The velocity v₁ in equation (13) is a displacement velocity (constant velocity) when the displaceable member 16 is further moved after having been moved to the predetermined position, and thus v₁ can be set freely by the user.

Accordingly, the total movement distance (displacement amount) S when the displaceable member 16 is displaced to the predetermined position after completion of the deceleration period is determined by the above equation (14). Since by converting equation (14) into the form of the above equation (15), an equation results for determining the constant velocity v₀, by substituting therein the movement data read out from the movement distance area 30, the constant velocity v₀ can also be calculated.

Further, the acceleration a₁ during the acceleration period of the second operating mode can be calculated by the above equation (16), by substituting the constant velocity v₀ calculated in equation (15) into equation (9) of Expression 1.

Similarly, the deceleration a₃ during the deceleration period can be represented by the above equation (17). Thus, by substituting the constant velocity v₀ into the above equation (18), which is converted from equation (17), the deceleration a₃ can be calculated.

In the foregoing manner, during the second operating mode as well, in which the displaceable member 16 is further displaced at a constant velocity after having been displaced to the predetermined position, the target value calculator 40 is capable of easily calculating values of the acceleration a₁, the acceleration time t₁, the constant velocity v₀, the constant velocity time t₂, the deceleration a₃, and the deceleration time t₃.

In the target value calculator 40, based on each of the above calculated values, a graph (refer to the upper side of the graph in FIG. 3) made up from a relationship between the movement time and the displacement amount of the displaceable member 16, or a graph (refer to the lower side of the graph in FIG. 3) made up from a relationship between the movement time and the displacement velocity of the displaceable member 16 can be formed. Thus, detailed displacement operations of the displaceable member 16 can be determined, and a target value of the displacement amount or the displacement velocity of the displaceable member 16, which is to be drive controlled, can be obtained at any arbitrary timing of the second operating mode.

It is a matter of course that the target value calculator 40 may also determine, by use of other methods (computational processes), a target value of the displacement amount or the displacement velocity of the displaceable member 16, which is to be drive controlled, at any arbitrary timing.

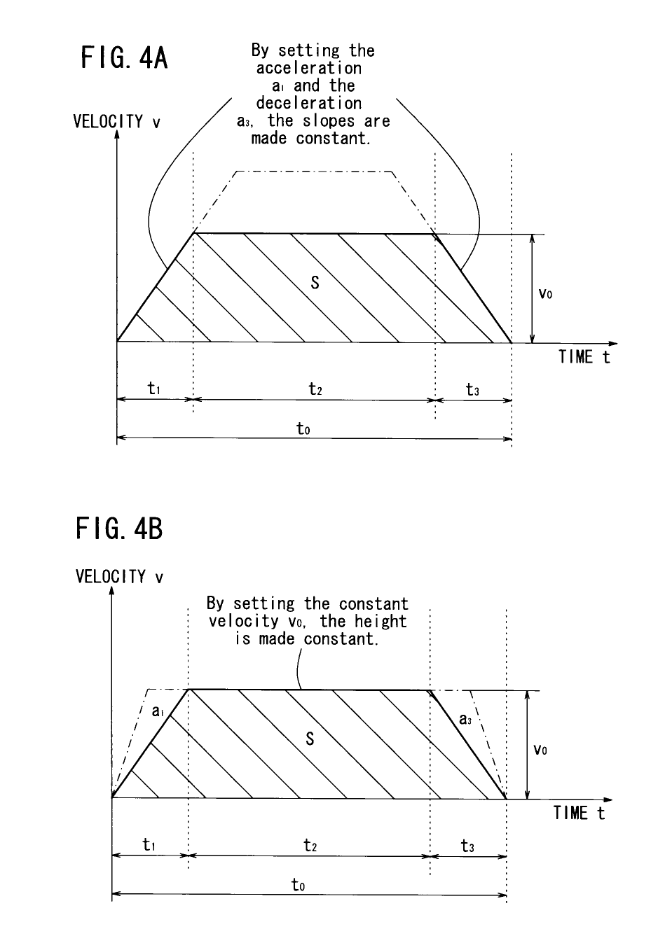

FIGS. 4A and 4B are graphs showing the relationship between time and velocity, which are descriptive of other methods for calculating the target value of a displacement amount or a displacement velocity of the displaceable member 16. By changing the information pertaining to the displacement velocity, apart from the calculation methods for the target value described above, with the following methods, the actuator drive control apparatus 10 can obtain a target value of the displacement amount or the displacement velocity of the displaceable member 16 at any arbitrary timing.

For example, in the case that the information pertaining to the displacement velocity is the acceleration a₁ and the deceleration a₃, the slopes exhibited by the acceleration and the deceleration in the graph of FIG. 4A are constant. Further, the movement distance S of the displaceable member 16 corresponds to the total area beneath the trapezoid formed by the movement time t₀ and the displacement velocity (refer to the portion shown by hatching in FIG. 4A). More specifically, since the shape of the trapezoid formed by the movement time t₀ and the displacement velocity can be specified by setting the movement distance S, the movement time t₀, the acceleration a₁, and the deceleration a₃ of the displaceable member 16, the other parameters (i.e., the acceleration time t₁, the constant velocity v₀, the constant velocity time t₂, and the deceleration time t₃) can be calculated.

Further, in the case that the movement distance S of the displaceable member 16 is large, then as shown by the one-dot-dashed line in FIG. 4A, by making the lengths of the acceleration time t₁ and the deceleration time t₃ longer, and thereby changing the value of the constant velocity v₀ (in this case, the constant velocity time t₂ becomes shorter), the target value required to displace the displaceable member 16 can be calculated without altering the preset acceleration a₁ and deceleration a₃. In this manner, the target value calculator 40 can automatically divide the movement time t₀ of the displaceable member 16 even if the information pertaining to the displacement velocity is simply the acceleration a₁ and the deceleration a₃ of the displaceable member 16.

On the other hand, in the case that the information pertaining to the displacement velocity is the constant velocity v₀ of the displaceable member 16, the height of the trapezoid formed by the movement time t₀ and the displacement velocity in the graph of FIG. 4B become constant. Accordingly, by setting the movement distance S, the movement time t₀, and the constant velocity v₀, the constant velocity time t₂ can be specified. In addition, from the constant velocity time t₂ and the movement time t₀, the percentages of the acceleration time t₁ and the deceleration time t₃ when the displaceable member is displaced can be determined, and corresponding to such percentages, the acceleration a₁ and the deceleration a₃ can be calculated.

Further, in the case that the movement distance S of the displaceable member 16 is large, then as shown by the one-dot-dashed line in FIG. 4B, by making the lengths of the constant velocity time t₂ longer, and changing the values of the acceleration a₁, the acceleration time t₁, the deceleration a₃, and the deceleration time t₃, the target value required to displace the displaceable member 16 can be calculated without altering the constant velocity v₀, which has been preset. In this manner, the target value calculator 40 can automatically divide the movement time t₀ of the displaceable member 16, even if the information pertaining to the displacement velocity is simply the constant velocity v₀.

Moreover, unlike the situation where the actuator drive control apparatus 10 maintains constant values for the acceleration a₁ and deceleration a₃ (i.e., the situation of FIGS. 2 through 4 in which the velocities during the acceleration period and the deceleration period change linearly), a configuration may be provided in which the acceleration a₁ or the deceleration a₃ can be changed gradually. For example, a configuration can be provided in which the acceleration a₁ and/or the deceleration a₃ are increased or decreased in a parabolic curve by a preset second order quadratic function.

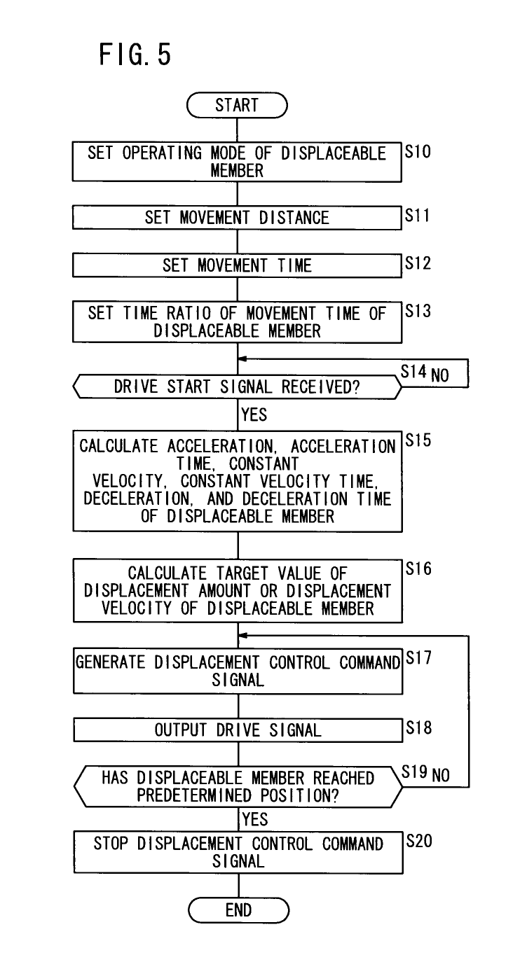

Next, a process flow in the case that the displaceable member 16 is displaced by the actuator drive control apparatus 10 shall be explained with reference to the flowchart of FIG. 5.

In the case that the displaceable member 16 is to be displaced, first, the operating mode setter 47e of the arithmetic operation unit 24 sets one operating mode from among the plural operating modes in which the target values of the displacement amount or the displacement velocity of the displaceable member 16 at any arbitrary time are modeled (step S1: operating mode setting step). More specifically, an operating mode as shown in FIG. 2, FIG. 3, etc., is selected by the user, and the selected operating mode is stored (set) in the operating mode area 38. Owing thereto, as needed, the arithmetic operation unit 24 can read out the selected operating mode.

Next, in the arithmetic operation unit 24, the movement distance of the displaceable member 16 from the movement start point to the predetermined position is set by the movement distance setter 47a (step S11: movement distance setting step). By the user inputting the predetermined position, the movement distance of the displaceable member 16 is automatically calculated as movement distance data. In addition, the calculated movement distance data is set by the movement distance setter 47a by storing the same in the movement distance area 30, so that the arithmetic operation unit 24 can read out the movement distance data as necessary. Of course, the movement distance data may also be input directly by the user and stored in the movement distance area 30.

Next, in the arithmetic operation unit 24, the movement time of the displaceable member 16 from the movement start point to the predetermined position is set by the movement time setter 47b (step S12: movement time setting step). The movement time data is set by the user by storing the same in the movement time area 32, so that the arithmetic operation unit 24 can read out the movement time data as needed.

Furthermore, from the operating mode that was selected in step S10, the arithmetic operation unit 24 sets the time ratio of the acceleration time, the constant velocity time, and the deceleration time when the displaceable member 16 is displaced (step S13).

Following step S13, the arithmetic operation unit 24 judges whether or not a drive start signal B_{S} to implement drive control of the actuator 12 has been received from the computer 14 (step S14).

In addition, when the drive start signal B_{S} is received from the computer 14, the target value calculator 40, using the above-described processes, calculates the acceleration, the acceleration time, the constant velocity, the constant velocity time, the deceleration, and the deceleration time from the set information (i.e., the time ratio, according to the present process flow) pertaining to the displacement velocity when the displaceable member 16 is displaced, the movement distance data, and the movement time data (step S15: target value calculation step (1)). In this manner, by calculating the displacement velocity, etc., of the displaceable member 16 at the time that the drive start signal B_{S} is received, the position at which the drive start signal B_{S} is received is set as the movement start point, and the movement distance therefrom to the predetermined position can be calculated.

Furthermore, the target value calculator 40 calculates a target value of the displacement amount or the displacement velocity of the displaceable member 16 at an arbitrary timing from each of the values of the calculated acceleration, the acceleration time, the constant velocity, the constant velocity time, the deceleration, and the deceleration time (step S16: target value calculation step (2)). As a result, a graph (e.g., the upper side of the graph in FIG. 2) made up from a relationship between the movement time and the displacement amount of the displaceable member 16, or a graph (e.g., the lower side of the graph in FIG. 2) made up from a relationship between the movement time and the displacement velocity of the displaceable member 16 is formed.

Thereafter, the target value calculator 40 of the arithmetic operation unit 24 generates displacement control command signals X_{S} over time, corresponding to the target value of the displaceable member 16 obtained in step S16, and outputs the displacement control command signals X_{S} to the drive controller 26 (step S17).

With the drive controller 26, the displacement control command signal X_{S} is corrected by the computing unit 48, and further, a drive signal D_{S} is generated in accordance with the target value and is output by the PID regulator 50 (step S18: drive control step). By inputting the drive signal D_{S} to the power amplifier 52, the drive signal D_{S} is amplified and is output as driving power P to the actuator 12.

Thereafter, by determining the passage of time, the arithmetic operation unit 24 judges whether or not the displaceable member 16 has reached the predetermined position (step S19). If the displaceable member 16 has not reached the predetermined position, then step S17 is returned to, and once again, displacement control command signals X_{S} are output over time.

On the other hand, in the case it is judged that the displaceable member 16 has reached the predetermined position, by stopping the displacement control command signal X_{S}, supply of driving power is stopped (step S20). Owing thereto, the displaceable member 16 can be stopped at the predetermined position. Further, together with stopping of the displaceable member 16, an operation completion signal F_{S} is sent to the computer 14, whereupon the fact that the displaceable member 16 has been stopped is displayed on the monitor or the like of the computer 14. In accordance with implementing the above steps, the actuator drive control apparatus 10 can displace the displaceable member 16 highly precisely to the predetermined position.

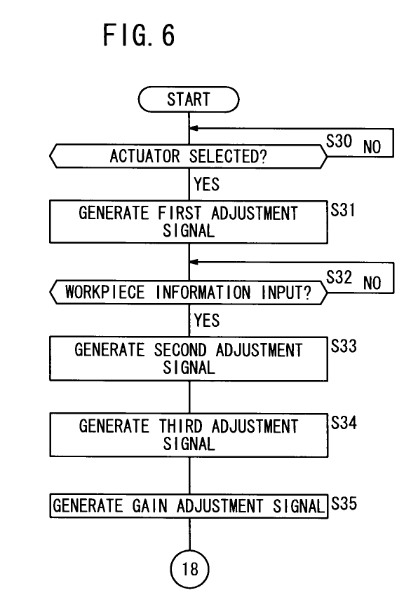

Further, when the displaceable member 16 is displaced by the actuator drive control apparatus 10, in the case that gain control of the drive signal D_{S} is carried out, the process flow shown in FIG. 6 is implemented.

In step S30 (specification data setting step), specification data of an actuator 12 to be controlled is set, from within a database in which specification data of actuators 12 (i.e., a resistance value, a thrust constant, the weight of the displaceable member 16, the stroke of the displaceable member 16, etc.), which are made up of a plurality of types or models, are stored. More specifically, when an actuator 12, which actually is to be used, is selected by the user, the specification data setter 47c stores (sets) the specification data of the actuator 12 in the specification data area 34. As a result, the arithmetic operation unit 24 can read out the specification data as needed.

Next, based on the specification data that was set in step S30, the first adjuster 44 generates a first adjustment signal for adjusting the drive signal (step S31: specification data gain adjusting step).

Further, in step S32 (workpiece information setting step), the workpiece information setter 47d of the arithmetic operation unit 24 stores (sets) in the workpiece information area 36 values of the weight, posture, load, etc., of the workpiece, as information of the workpiece on which predetermined actions are to be effected along with displacement of the displaceable member 16. Consequently, the arithmetic operation unit 24 can read out as needed the values of the weight, posture and load, etc.

Next, based on the workpiece information set in step S32, the second adjuster 45 generates a second adjustment signal for adjusting the drive signal (step S33: workpiece information gain adjusting step).

Further, in step S34 (movement information gain adjusting step), the movement distance setter 47a of the arithmetic operation unit 24 reads out the set movement distance, or the movement time setter 47b of the arithmetic operation unit 24 reads out the set movement time. Based on the movement distance and the movement time, which have been set, a third adjustment signal is generated in the third adjuster 46 for adjusting the drive signal.

Thereafter, in the arithmetic operation unit 24, the first through third adjustment signals are integrated, and a gain adjustment signal G_{S} to be output from the gain adjuster 42 is generated. The gain adjustment signal G_{S} is sent to the drive controller 26 (step S35).

The drive controller 26, upon receipt of the gain adjustment signal G_{S}, can properly adjust the drive signal D_{S} that was generated in step S18. Driving power P made up from the adjusted drive signal D_{S} is output from the actuator drive control apparatus 10, whereby the displaceable member 16 can be displaced with high precision.

In the foregoing manner, by means of the actuator drive control apparatus 10 according to the present embodiment, by setting the displacement distance and the displacement time of the displaceable member 16 that makes up the actuator 12, detailed operations of the displaceable member 16 can be determined, and the displaceable member 16 can be displaced with high precision. Thus, for example, in the case that a workpiece is transported or pressed by the displaceable member 16 up to a predetermined position, the workpiece can be displaced to the predetermined position within a desired time. Further, since the user is not required to calculate detailed driving conditions such as the velocity of the displaceable member 16, the time over which the velocity is maintained, and the like, the work burden on the user can significantly be lessened.

Further, because the actuator drive control apparatus 10 makes use of the computer 14 with the object of data inputting the operating conditions of the displaceable member 16, compared to a case in which target values of the displaceable member 16 are calculated inside the computer 14 and the displaceable member 16 is controlled thereby, the data transmission rate can be reduced, and an inexpensive serial transmission connection cable or the like, which is suitable for a low transmission rate, can be applied.

The present invention is not limited to the above-described embodiment, and as a matter of course, various additional or modified structures may be adopted without deviating from the essence or gist of the present invention.

For example, with the actuator drive control apparatus 10 according to the present embodiment, in the target value calculator 40, a configuration is provided in which a displacement control command signal X_{S} is generated as a signal for controlling displacement of the displaceable member 16. However, the target value calculator 40 may also be configured so as to generate a velocity control command signal to control the displacement velocity of the displaceable member 16, whereby the displaceable member 16 is displaced responsive to such a velocity control command signal.

Further, by means of the process flow of the actuator drive control apparatus 10 shown in FIG. 6, calculations are performed after the movement distance and the movement time of the displaceable member 16, and the driving start signal B_{S} have been received. However, the invention is not limited by this feature. For example, calculations may be performed when a predetermined position and movement time are input upon displacement of the displaceable member 16.

Furthermore, the actuator drive control apparatus 10 is not limited solely to a configuration in which the actuator drive control apparatus 10 is constituted separately from the computer 14 or the PLC 15, and the actuator 12 may be constituted integrally as a single control apparatus for carrying out drive control.

What is claimed is:

1. An actuator drive control apparatus for displacing a displaceable member of an actuator to a predetermined position, comprising:
a movement distance setting means for setting a movement distance of the displaceable member from a movement start point to the predetermined position;
a movement time setting means for setting a movement time for the displaceable member to move from the movement start point to the predetermined position;
a target value calculating means for automatically dividing the movement time into an acceleration time, a constant velocity time, and a deceleration time based on preset information related to a displacement velocity when the displaceable member is displaced, and for calculating a target value of a displacement amount or a displacement velocity of the displaceable member at an arbitrary timing based on the divided movement time and the movement distance; and
a drive control means for displacing the displaceable member to the predetermined position by controlling driving of the actuator based on the target value of the displacement amount or the displacement velocity of the displaceable member.

2. The actuator drive control apparatus according to claim 1, wherein:
the information related to the displacement velocity is a time ratio of the acceleration time, the constant velocity time, and the deceleration time of the displaceable member; and
the target value calculating means automatically divides the movement time based on the time ratio.

3. The actuator drive control apparatus according to claim 1, wherein:
the information related to the displacement velocity are the acceleration time, the constant velocity time, and the deceleration time of the displaceable member; and
the target value calculating means determines a time ratio of the acceleration time, the constant velocity time, and the deceleration time, using at least two times from among the acceleration time, the constant velocity time, and the deceleration time, and automatically divides the movement time based on the time ratio.

4. The actuator drive control apparatus according to claim 1, wherein:
the information related to the displacement velocity comprises acceleration and deceleration of the displaceable member; and
the target value calculating means automatically divides the movement time by the acceleration and the deceleration.

5. The actuator drive control apparatus according to claim 1, wherein:
the information related to the displacement velocity comprises a constant velocity of the displaceable member; and
the target value calculating means automatically divides the movement time by the constant velocity.

6. The actuator drive control apparatus according to claim 1, wherein the target value calculating means calculates the acceleration, the acceleration time, the constant velocity, the constant velocity time, the deceleration, and the deceleration time of the displaceable member respectively from the information related to the displacement velocity, the movement distance, and the movement time, and based on a calculation result thereof, calculates the target value of the displacement amount or the displacement velocity of the displaceable member at the arbitrary timing.

7. The actuator drive control apparatus according to claim 1, wherein the drive control means controls driving of the actuator so that the displacement velocity changes in order through an acceleration phase, a constant velocity phase, and a deceleration phase, during one displacement of the displaceable member.

8. The actuator drive control apparatus according to claim 7, wherein the target value calculating means calculates the target value of the displacement amount or the displacement velocity of the displaceable member at the arbitrary timing, such that the acceleration time is shorter than the deceleration time.

9. The actuator drive control apparatus according to claim 1, wherein the drive control means is constituted to control driving of the actuator by generating a drive signal based on the target value of the displacement amount or the displacement velocity of the displaceable member, further comprising:
a specification data setting means for setting, as specification data of actuators made up from a plurality of types or models, specification data of the actuator, which is controlled, from a database in which at least one value is stored beforehand from among a resistance value, a thrust force constant, a weight of the displaceable member, and a stroke of the displaceable member; and
a specification data gain adjustment means that transmits a gain adjustment signal for adjusting the drive signal generated in the drive control means, based on the specification data, which has been set.

10. The actuator drive control apparatus according to claim 1, wherein the drive control means is constituted to drive the actuator by generating a drive signal based on the target value of the displacement amount or the displacement velocity of the displaceable member, further comprising:
a workpiece information setting means for setting, as workpiece information for effecting a predetermined operation along with displacement of the displaceable member, a value of at least one of a weight, a posture, and a load; and
a workpiece information gain adjustment means that transmits a gain adjustment signal for adjusting the drive signal generated in the drive control means, based on the workpiece information, which has been set.

11. The actuator drive control apparatus according to claim 1, wherein the drive control means is constituted to control driving of the actuator by generating a drive signal based on the target value of the displacement amount or the displacement velocity of the displaceable member, further comprising:
a movement information gain adjusting means that transmits a gain adjustment signal for adjusting the drive signal generated in the drive control means, based on the movement distance set by the movement distance setting means, or the movement time set by the movement time setting means.

12. The actuator drive control apparatus according to claim 1, further comprising:
an operating mode setting means for setting any one of a plurality of operating modes, in the case that a plurality of the operating modes, the acceleration time, the constant velocity time, and the deceleration time of which are different, are stored beforehand,
wherein the target value calculating means calculates the target value of the displacement amount or the displacement velocity of the displaceable member at the arbitrary timing, based on the operating mode, which has been set.

13. The actuator drive control apparatus according to claim 12, wherein a velocity of the displaceable member at the predetermined position is set by the operating mode.

14. The actuator drive control apparatus according to claim 12, wherein:
an external apparatus capable of setting a plurality of the operating modes is connected to the actuator drive control apparatus;
the operating mode setting means sets the operating mode, which has been sent at a predetermined timing from the external apparatus; and
the target value of the displacement amount or the displacement velocity of the displaceable member is calculated based on the operating mode, which has been set.

15. An actuator drive control method for displacing a displaceable member of an actuator to a predetermined position, comprising:
a movement distance setting step of setting a movement distance of the displaceable member from a movement start point to the predetermined position;
a movement time setting step of setting a movement time for the displaceable member to move from the movement start point to the predetermined position;
a target value calculating step of automatically dividing the movement time into an acceleration time, a constant velocity time, and a deceleration time based on preset information related to a displacement velocity when the displaceable member is displaced, and of calculating a target value of a displacement amount or a displacement velocity of the displaceable member at an arbitrary timing based on the divided movement time and the movement distance; and
a drive control step of displacing the displaceable member to the predetermined position by controlling driving of the actuator based on the target value of the displacement amount or the displacement velocity of the displaceable member.

16. The actuator drive control method according to claim 15, wherein:
the information related to the displacement velocity is a time ratio of the acceleration time, the constant velocity time, and the deceleration time of the displaceable member; and
in the target value calculating step, the movement time is automatically divided based on the time ratio.

17. The actuator drive control method according to claim 15, wherein:
the information related to the displacement velocity is a time ratio of the acceleration time, the constant velocity time, and the deceleration time of the displaceable member; and
in the target value calculating step, the time ratio of the acceleration time, the constant velocity time, and the deceleration time is determined using at least two times from among the acceleration time, the constant velocity time, and the deceleration time, and the movement time is automatically divided based on the time ratio.

18. The actuator drive control method according to claim 15, wherein:
the information related to the displacement velocity comprises acceleration and deceleration of the displaceable member; and
the target value calculating step automatically divides the movement time by the acceleration and the deceleration.

19. The actuator drive control method according to claim 15, wherein:
the information related to the displacement velocity comprises a constant velocity of the displaceable member; and
the target value calculating step automatically divides the movement time by the constant velocity.

20. The actuator drive control method according to claim 15, wherein, in the target value calculating step, the acceleration, the acceleration time, the constant velocity, the constant velocity time, the deceleration, and the deceleration time of the displaceable member are calculated respectively from the information related to the displacement velocity, the movement distance, and the movement time, and based on a calculation result thereof, the target value of the displacement amount or the displacement velocity of the displaceable member is calculated at the arbitrary timing.

21. The actuator drive control method according to claim 15, wherein, in the drive control step, driving of the actuator is controlled so that the displacement velocity changes in order through an acceleration phase, a constant velocity phase, and a deceleration phase, during one displacement of the displaceable member.

22. The actuator drive control method according to claim 21, wherein, in the target value calculating step, the target value of the displacement amount or the displacement velocity of the displaceable member at the arbitrary timing is calculated such that the acceleration time is shorter than the deceleration time.

23. The actuator drive control method according to claim 15, wherein, in the drive control step, a drive signal for controlling driving of the actuator is generated, based on the target value of the displacement amount or the displacement velocity of the displaceable member, further comprising:
a specification data setting step of setting, as specification data of actuators made up from a plurality of types or models, specification data of the actuator, which is controlled, from a database in which at least one value is stored beforehand from among a resistance value, a thrust force constant, a weight of the displaceable member, and a stroke of the displaceable member; and
a specification data gain adjustment step that transmits a gain adjustment signal for adjusting the drive signal generated in the drive control step, based on the specification data, which has been set.

24. The actuator drive control method according to claim 15, wherein, in the drive control step, a drive signal for controlling driving of the actuator is generated, based on the target value of the displacement amount or the displacement velocity of the displaceable member, further comprising:
a workpiece information setting step of setting, as workpiece information for effecting a predetermined operation along with displacement of the displaceable member, a value of at least one of a weight, a posture, and a load; and
a workpiece information gain adjustment step of transmitting a gain adjustment signal for adjusting the drive signal generated in the drive control step, based on the workpiece information, which has been set.

25. The actuator drive control method according to claim 15, wherein, in the drive control step, a drive signal is generated for controlling driving of the actuator, based on the target value of the displacement amount or the displacement velocity of the displaceable member, further comprising:
a movement information gain adjusting step of transmitting a gain adjustment signal for adjusting the drive signal generated in the drive control step, based on the movement distance set by the movement distance setting step, or the movement time set by the movement time setting step.

26. The actuator drive control method according to claim 15, further comprising:
an operating mode setting step of setting any one of a plurality of operating modes, the acceleration time, the constant velocity time, and the deceleration time of which are different,
wherein, in the target value calculating step, the target value of the displacement amount or the displacement velocity of the displaceable member at the arbitrary timing is calculated, based on the operating mode, which has been set.

27. The actuator drive control method according to claim 26, wherein a velocity of the displaceable member at the predetermined position is set in the operating mode.

28. The actuator drive control method according to claim 26, wherein:
an external apparatus capable of setting a plurality of the operating modes is connected to an actuator drive control apparatus that controls driving of the actuator;
in the operating mode setting step, the operating mode, which has been sent at a predetermined timing from the external apparatus, is set; and
in the target value calculating step, the target value of the displacement amount or the displacement velocity of the displaceable member is calculated based on the operating mode, which has been set.
